(19) United States
(12) Patent Application Publication
(10) Pub. No.: US 2025/0378845 A1
(43) Pub. Date: Dec. 11, 2025

(54) Systems and methods for soft event detection with event-level thresholding

(71) Applicant: Mitsubishi Electric Research Laboratories, Inc., Cambridge, MA (US)

(72) Inventors: Janek Ebbers, Cambridge, MA (US); François G Germain, Quincy, MA (US); Gordon Wichern, Boston, MA (US); Jonathan Le Roux, Arlington, MA (US)

(73) Assignee: Mitsubishi Electric Research Laboratories, Inc., Cambridge, MA (US)

(21) Appl. No.: 18/734,621

(22) Filed: Jun. 5, 2024

(51) Int. Cl. G10L 25/78; G10L 25/51

(52) U.S. Cl. CPC G10L 25/78; G10L 25/51; G10L 2025/783

(57) ABSTRACT

A system for event detection in time-series data comprises a memory configured to store computer-executable instructions and one or more processors configured to execute the instructions to process the time-series data to make a hard decision on a time span of an event indicative of continuous activity of the event within the time-series data and make a soft decision on a presence of the event for the entire time span. The one or more processors are further configured to apply an event-level threshold to the soft decision on the presence of the event for the entire time span to produce a result of the event detection and output the result of the event detection.

### TECHNICAL FIELD

This invention relates generally to data processing for event detection in time series data for real world applications such as control tasks and more particularly to systems and methods for processing the time-series data to make soft event detection with event-level thresholding.

### BACKGROUND

Several real-world applications require identifying events in time-series data to perform certain tasks. The time-series data may be a mixture of data provided by different sources or data of different types. Detecting events may comprise detecting segments of the time series data that belong to a particular type, or that indicate certain events in time. In this regard, the processing of the time series data may involve applying data labels to each segment of the time-series data and grouping them into groups of those labels. One example of such detection is sound event detection (SED) in audio streams which is the task of identifying sounds in an input audio clip and providing for each sound event, its onset time, offset time and sound class (e.g., glass breaking). SED systems can be used in various applications, e.g., multimedia analysis, autonomous driving, surveillance and machine condition monitoring.

The ultimate goal of sound event detection (SED) may be to identify time spans in which a specific sound class is present, which may be referred to as an event (e.g., “Dog barking” from 3.2 s to 3.8 s). Available methods have so far either outputted hard event detections directly (i.e., predicted time span boundaries and sound class) or soft detections (providing a continuous value between 0 and 1, which indicates the presence probability of the class) at the short-time (or frame) level.

Conventional approaches commonly predict sound presence likelihoods in short time frames and then implement frame-level thresholding to produce binary frame-level presence decisions, with the extent of individual events determined by merging consecutive positive frames. The frame-level threshold is commonly used to control a system's sensitivity. However, such frame-level thresholding is sub-optimal because adjusting the frame-level threshold also affects the predicted extent of an event.

### SUMMARY

Contrary to conventional approaches which utilize frame-level thresholding for event detection, it is an objective of some example embodiments to provide an event detection framework that is based on event-level thresholding of event candidates. Several example embodiments described herein are directed towards systems and methods for automatically recognizing and processing sounds in diverse environments to perform robust sound event detection (SED).

It is a realization of some embodiments that data processing for event detection in time-series data is an essential process for several real-world applications. For example, event detections may be utilized as a trigger for executing one or more processes such as control and manipulation in machines. Some embodiments also recognize that for efficient and robust execution of such processes, precise detection of such events is important. Usually, labels are assigned to individual segments of data in the time-series data when such segments exhibit resemblance to one or more categoric properties. Such resemblance may be judged in terms of a probability score, also referred to as a presence confidence, and those segments that satisfy a threshold criterion may be considered as pieces of a detected event. However, some embodiments recognize that determining the extent of an event requires merging of such event pieces and a careful selection of the threshold criterion.

Available SED systems rely on frame-level event presence detection models and as such, thresholding of the frame-level event presence confidence alone cannot directly output event predictions. Some embodiments are based on the realization that post-processing is needed to consolidate frame-level event presence predictions into event predictions. It is also a realization that one way of post processing involves computing event predictions as blocks of consecutive frame-level presence predictions (i.e., confidences falling above the aforementioned threshold). The threshold then controls the minimum presence confidence triggering an event detection in a binary fashion. Some embodiments recognize that while such thresholding allows flexibility as per the end use application requirements, it also means that varying the threshold will also affect the event predictions in non-trivial and detrimental ways. For example, additional frame-level detections due to a lower threshold can change the detected onset/offset times of a predicted event, or even merge multiple predicted events into a single one. This is highly undesirable for crucial applications requiring high precision in the event detection.

The need for a precise event extent detection arises from the fact that for applications seeking meaningful connected event predictions, event-based evaluation is employed. Common errors in this event detection framework are false alarms and missed hits due to a false/imprecise extent detection. With conventional approaches relying on frame-level thresholding (i.e., applying a threshold to each frame of time-series data) for event detection, errors occur due to the entanglement of the number of detected events and event extent prediction. It is an objective of some example embodiments to remedy the aforementioned errors while performing event detection. Furthermore, the choice of threshold level is subjective and varies from one application to another. However, it is a realization of some example embodiments that while having a very high frame-level threshold may lead to missed hits, a lower frame-level threshold may trigger large number of event detections but is detrimental to detection of time span of the detected events. Therefore, frame-level thresholding is suboptimal for event detection due to the event-level entanglement of both boundary and confidence information in the frame-level scores. Accordingly, some example embodiments propose to decouple the extent and confidence prediction of event detections.

In this regard, within the context of sound event detections, some example embodiments provide sound event bounding boxes (SEBBs) as the output format of an SED system. That is, some example embodiments provide a new structure for SED systems to explicitly decouple the prediction mechanisms for onset/offset times and event presence, by introducing the sound event bounding boxes (SEBBs) output format. The SEBB format corresponds to a series of event-level candidates with each having a predicted class, onset/offset times and a (scalar) presence confidence. Then, predicted events become a series of SEBBs whose presence confidence exceeds an event-level confidence threshold instead of the conventional frame-level threshold. Crucially, this threshold now intuitively controls only whether an SEBB is predicted as an event, without affecting its onset/offset times, and eliminates the undesirable behaviors observed with the conventional approaches. Thus, some embodiments are based on a postulation that the temporal extent of event candidates should be determined independently from the event candidate confidence score. An event-level thresholding can then be employed to control a system's sensitivity without affecting the temporal extents of event predictions. This is because even if the decision threshold is lowered far below an SEBB's confidence score, the temporal extent will not change. This ensures not to disturb high-confidence event detections when using low decision thresholds, such as in applications aiming for a high recall.

Some example embodiments also provide post-processing techniques to convert the frame-level presence confidence scores into SEBBs for any frame-level system. Such a conversion relies primarily on a change/slope-based approach along with an absolute confidence of an event detection belonging to a certain class. Some example embodiments also provide a hybrid approach for generating SEBB predictions that utilizes a threshold based SEBB generation approach complemented with a change detection based SEBB generation approach.

In order to achieve the aforesaid objectives and advantages, some embodiments provide systems and methods for event prediction in time series data.

Accordingly, one embodiment provides a computer-implemented method for event detection in time-series data. The method uses a processor coupled with a memory configured to stored instructions implementing the method. The method comprises processing the time-series data to i.) make a hard decision on a time span of an event indicative of continuous activity of the event within the time-series data and ii.) make a soft decision on a presence of the event for the entire time segment. The method also comprises applying an event-level threshold to the soft decision on the presence of the event for the entire time segment to produce a result of the event detection and outputting the result of the event detection.

In yet another embodiment, a system for event detection in time-series data is provided. The system comprises a memory configured to store computer-executable instructions and one or more processors configured to execute the instructions to process the time-series data to i.) make a hard decision on a time span of an event indicative of continuous activity of the event within the time-series data and ii.) make a soft decision on a presence of the event for the entire time segment. The one or more processors are further configured to apply an event-level threshold to the soft decision on the presence of the event for the entire time segment to produce a result of the event detection and output the result of the event detection.

### BRIEF DESCRIPTION OF THE DRAWINGS

The presently disclosed embodiments will be further explained with reference to the following drawings. The drawings shown are not necessarily to scale, with emphasis instead generally being placed upon illustrating the principles of the presently disclosed embodiments.

FIG. 1A illustrates a block diagram of an event detection-based control system for controlling a machine in accordance with events detected in time series data, according to some example embodiments;

FIG. 1B illustrates a sound event detection (SED) system as one example of the event detection system of FIG. 1A, according to some example embodiments;

FIG. 2A illustrates a block diagram of an event detection system of the event detection-based control system of FIG. 1A, according to some example embodiments;

FIG. 2B illustrates schematics of a multi-label classifier of the event detection system of FIG. 2A, according to some example embodiments;

FIG. 2C illustrates a structure of the SED system of FIG. 1B when employing soft detection at frame-level;

FIG. 3A, 3B, and 3C illustrate examples of event detections using different frame-level thresholds;

FIG. 4A illustrates a framework for generating event-level hard detections from time series data using end-to-end event bounding box detection followed by event-level thresholding, according to some example embodiments;

FIG. 4B illustrates a modified framework for event detection, according to some example embodiments;

FIG. 4C illustrates a framework for generating event-level soft detections from frame-level soft detections using event-level thresholds, according to some example embodiments;

FIG. 4D illustrates an exemplary graphical representation of an event detection output format as event bounding boxes, according to some example embodiments;

FIG. 5 illustrates a workflow of a method for change-detection based prediction of sound event bounding boxes from frame-level class presence confidence scores, according to some example embodiments;

FIG. 6 illustrates a graphical representation of change-detection based prediction of sound event bounding boxes, according to some example embodiments;

FIG. 7A illustrates schematics of change detection using local maximas and minimas of delta scores computed for frames of time-series data, according to some example embodiments;

FIG. 7B illustrates schematics of merging of tentative events for the change-detection based prediction of sound event bounding boxes, according to some example embodiments;

FIG. 8 illustrates some components of the event detection-based control system of FIG. 1A, according to some example embodiments; and

FIG. 9 illustrates an example use case of the event detection system of FIG. 1B, according to some embodiments.

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in the art which fall within the scope and spirit of the principles of the presently disclosed embodiments.

### DETAILED DESCRIPTION

The following description provides exemplary embodiments only, and is not intended to limit the scope, applicability, or configuration of the disclosure. Rather, the following description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the following description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like-reference numbers and designations in the various drawings may indicate like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine-readable medium. A processor(s) may perform the necessary tasks.

Processing time-series data for event detection is an essential process for several real-world applications. For example, event detections may be utilized as a trigger for executing one or more processes such as control and manipulation in machines. The time-series data may be a mixture of data provided by different sources or data of different types. Detecting events may comprise detecting segments of the time series data that belong to a particular type, or that indicate certain events in time. One example of such event detection is sound event detection (SED) in audio streams which includes the task of identifying sounds in an input audio clip and providing for each sound event, its onset time, offset time and a sound class. The sound class may be configurable and chosen according to the end use application.

For efficient and robust execution of such processes, precise detection of such events is important. Event detection is usually a hierarchical process that comprises making hard decisions on event detection from soft decisions on shorter segments of the time-series data commonly referred to as frames of the data. These frames are defined at short time levels of the entire span of the time-series data.

To eventually obtain hard event detections, a two-prong approach may be followed. Firstly, short-time level soft detections may be converted into short-time level hard detections with a given detection threshold (the minimum class presence probability for which the class is detected as present within the considered short-time segment/frame). Then hard event detections may be derived by merging neighboring short-time level hard detections into a single time segment/event. The detection threshold is specified by the user and allows to control the system's sensitivity. Lowering the threshold makes the system detect more class presence (hence increasing the system's sensitivity). As event detections are derived from frame-level hard detections, the time spans of events are thus highly entangled with the detection threshold/sensitivity. For example, lowering the threshold can result in both more detected events, but simultaneously increase the predicted duration of events that have already been detected with a higher threshold.

To address this issue, example embodiments described herein instead output soft event detections which are fixed time spans associated with a sound class and an event presence probability (e.g., “Dog barking” from 3.2 s to 3.8 s with probability 70%). These can also be understood as event candidates with a respective event presence probability assigned to each of them. Hard event detections can then be eventually derived from soft event detections by applying a detection threshold (again provided by the user to control sensitivity) at the event level. Doing this in such a manner, the threshold determines only the presence probability above which the system accepts event candidates as actual detections, whereas event candidates with lower presence probability are discarded. In contrast to frame-level thresholding, the event-level threshold has no influence on the event's extent/time span. That is, changing the threshold does not alter the span of detected events with the event-level thresholding approach.

For example, consider a system that predicts a first event as “Dog barking” from 3.2 s to 3.8 s with a probability of dog barking equaling 70% and a second event as “Dog barking” from 6.3 s to 6.6 s with probability of dog barking being 40%. If an event-level threshold (minimum required event probability) of “greater than 50%” is applied, it yields hard event detections of only “Dog barking” from 3.2 s to 3.8 s (i.e., the first event detection), as the second one from 6.3 s to 6.6 s is discarded due to its probability being less than 50%. If a higher sensitivity is required, the threshold may be set to “greater than 30%” in which case the second event is also accepted as a hard detection without impacting the duration of the first detected event.

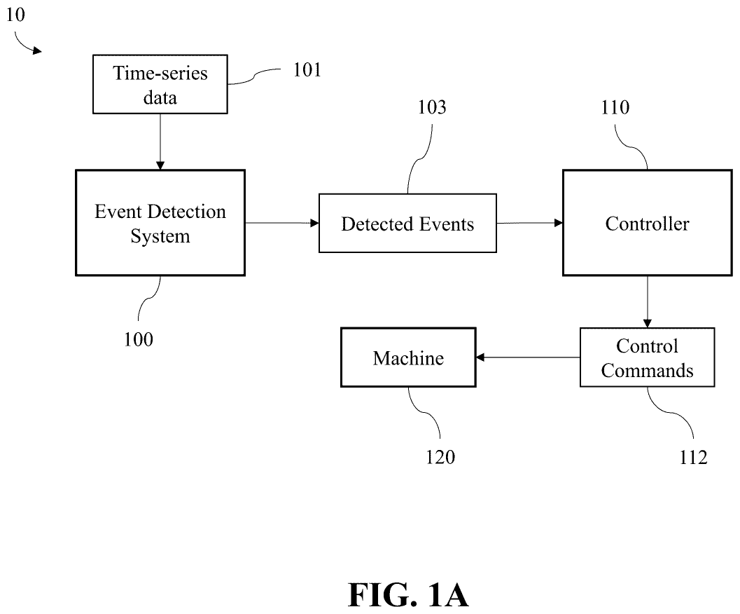

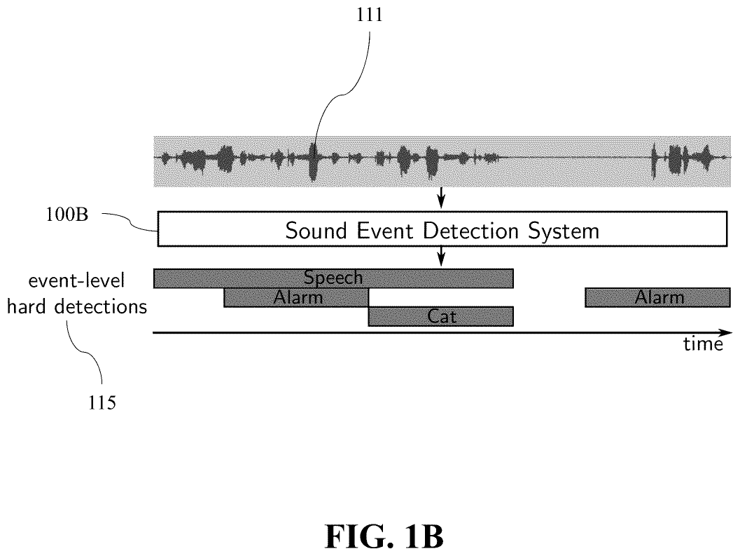

FIG. 1A illustrates a block diagram of an event detection-based control system 10 for controlling a machine 120 in accordance with events 103 detected in time series data 101, according to some example embodiments. For example, the control system 10 may be configured to perform control of one or more operations of an autonomous vehicle in accordance with events detected in speech data provided by a passenger of the vehicle. In some other embodiments, the control system 10 may be configured to trigger generation of a video clip from video recording of a wildlife scene upon detection of one or more events pertaining to certain animals in audio data or video data of the video recording.

The control system 10 comprises an event detection system 100 configured to generate one or more event detections 103 from the time-series data 101. The control system 10 also comprises a controller 110 configured to generate one or more control commands 112 to control a machine 120 in accordance with the detected events 103. Each of the detected events 103 may be defined in terms of data such as an event class, an onset time of the event, an offset time of the event, and a confidence score of the event belonging to the event class. Thus, at least in part, each of the detected events 103 may comprise a part or whole of the time-series data 101. For example, the onset time and offset time of an event may correspond to time instances on a time-axis of the time-series data 101.

With respect to the control of the machine 120 by the controller 110, the time-series data 101 may be historical data collected over a period of time. In some embodiments, the time-series data 101 may correspond to live or real-time data that is buffered in a temporary storage device and processed in a piecewise manner by the control system 10. In such embodiments, the time-series data 101 may be processed as blocks of data of fixed or variable sizes to perform the event detection. The controller 110 may process the detected events 103 to trigger and execute one or more control actions on the machine 120. For example, where the time-series data corresponds to an audio stream and the event detection system 100 detects utterances of certain sounds that correspond to one or more functionalities of the machine 120, the controller 110 generates control commands 112 that execute the functionalities of the machine 120. One example of the utterances may be a voice command from an occupant of a vehicle to turn on the air conditioning of the vehicle. In such cases, the controller 110 may process an event corresponding to the utterance as a voice command and turn on the air conditioning system of the vehicle.

From the aforementioned examples, it is evident that for effective control of the machine 120, it is crucial that the event detection system 100 detects the events with such a level of precision that is acceptable for the end use application. For example, an improper event detection may lead to labeling of the time-series data into an incorrect class and/or the detected onset/offset time may be improperly identified. Any of these may lead to an incorrect control command being implemented on the machine 120. For the event detection to be precise, it is desirable for the detected event to be applicable to different threshold levels of the confidence score without modification of the timespan.

FIG. 1B illustrates a sound event detection system 100B as one example of the event detection system 100 of FIG. 1A, according to some example embodiments. The sound event detection system 100B takes as input an audio stream 111 and outputs a list of detected events 115. The audio stream 111 may be continuous in time and have a length in time. For the sake of an example, it may be assumed that the audio stream is 8 s long and event onsets and offsets are predicted as a multiple of 1 s. Each row of the detections 115 refers to a different sound class/type and multiple sounds can be active at a time. In the example shown in FIG. 1B, four events have been detected namely (“Speech” from 0 s to 5 s; “Alarm” from 1 s to 3 s; “Alarm” from 6 s to 8 s; “Cat” from 3 s to 5 s).

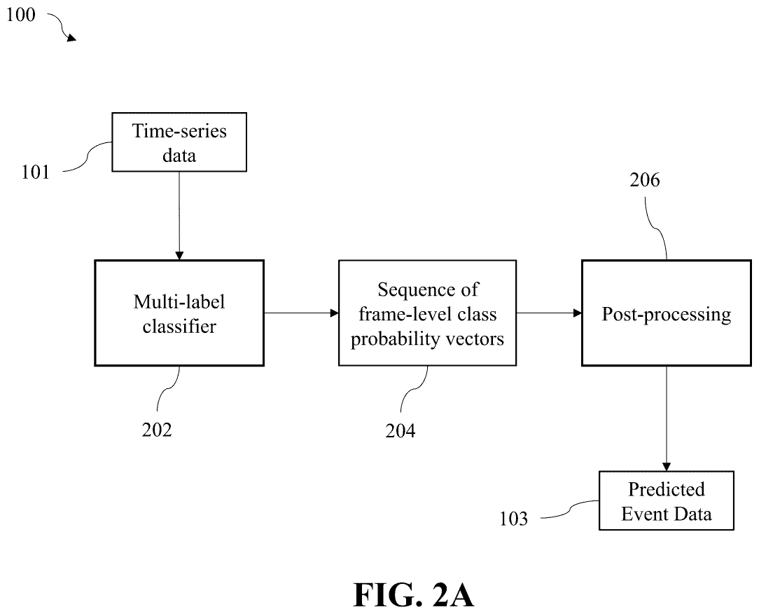

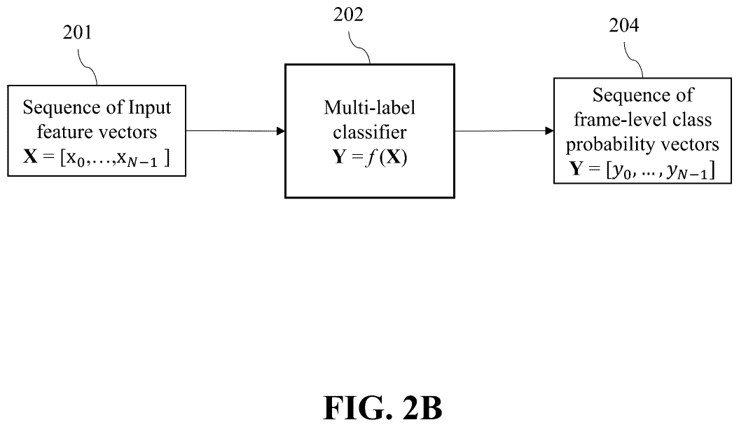

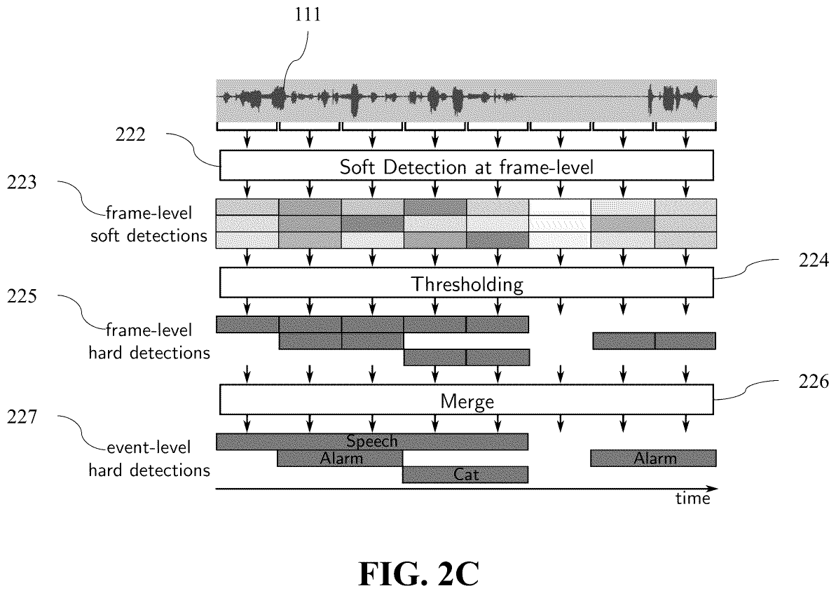

FIG. 2A illustrates a block diagram of the event detection system 100 of FIG. 1A, according to some example embodiments. The event detection system 100 comprises a multi-label classifier 202 that generates a sequence of frame-level class probability vectors 204 from the time-series data 101. The post processing module 206 outputs the predicted/detected events 103 from the sequence of frame-level class probability vectors 204.

As is illustrated in FIG. 2B, in mathematical terms, the classifier 202 corresponds to the operation Y=f(X) with f denoting a prediction model, X=[x₀, . . . , x_{N-1}] a sequence of input feature vectors 201 xₙ (for example log-mel spectrogram frames in case of audio input), and Y=[y_0, . . . , y_(N−1)] a sequence of frame-level class probability vectors 204 yₙ, with n being the frame index. According to some embodiments, the prediction model f may be a convolutional neural network (CNN) with striding and/or pooling. From the sequence of frame-level class probability vectors 204, a predicted confidence 205 of sound class c being present in frame n, represented as y_{n,c}∈[0,1] may be inferred.

Referring to FIG. 2A, the sequence of frame-level class probability vectors 204 yₙ may be fed to post processing module 206. One approach for post processing may comprise first (optionally) altering the frame-level class probability vectors 204 yₙ e.g., by median filtering y_{n,c} in times. Event predictions 103 may be obtained through a frame-level thresholding operation, turning y_{n,c} into a binary z_{n,c}= [symbol] _{[y}_{_{n,c}}_{>λ}_{_{c}}_{]} (with λ_{c} being a class-dependent threshold), followed by a merging operation where each block of consecutive z_{n,c}= [symbol] is merged into a single detected event êⱼ. The detected onset time then corresponds to the beginning of the first frame of that block while the detected offset time corresponds to the end of the last frame of that block.

FIG. 2C shows the structure of the SED system 100B of FIG. 1B, when employing soft detection at frame-level. For each frame (different columns represent different frames) and each sound class (different rows represent different classes), the detection model performs soft detection at frame level 222 and outputs as frame level soft detection 223 a soft (or continuous) value which can be any real number between 0 and 1 that represents a predicted class presence probability (represented by the hue). To convert/binarize soft detections 223 into hard detections 225, a thresholding 224 is employed, where for each sound class a different threshold may be used. If the probability 223 exceeds the threshold at 224, the class is assumed present in the frame. Finally, the binary frame-level hard detections 225 are converted into event-level hard detections 227 (the final output of the SED system 100B) by merging 226 neighboring detections into the same event.

It may be noted that some models may compute event predictions as blocks of consecutive frame-level presence predictions (i.e., confidences falling above the aforementioned threshold). As traditionally understood in detection tasks, the threshold then controls the minimum presence confidence triggering an event detection in a binary fashion. As such, appropriate threshold value(s) can be chosen depending on application requirements, with, for example, some applications requiring high recall and others high precision. Crucially, these approaches mean varying the threshold will also affect the event predictions.

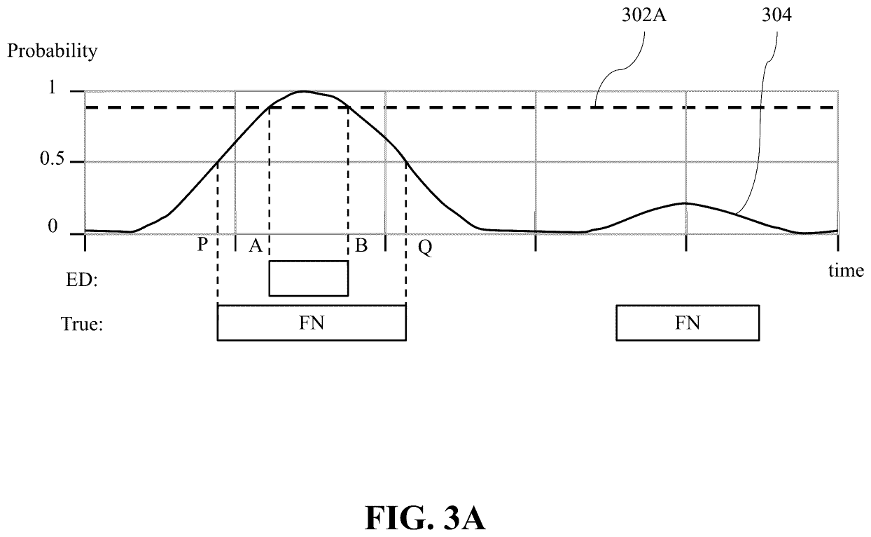

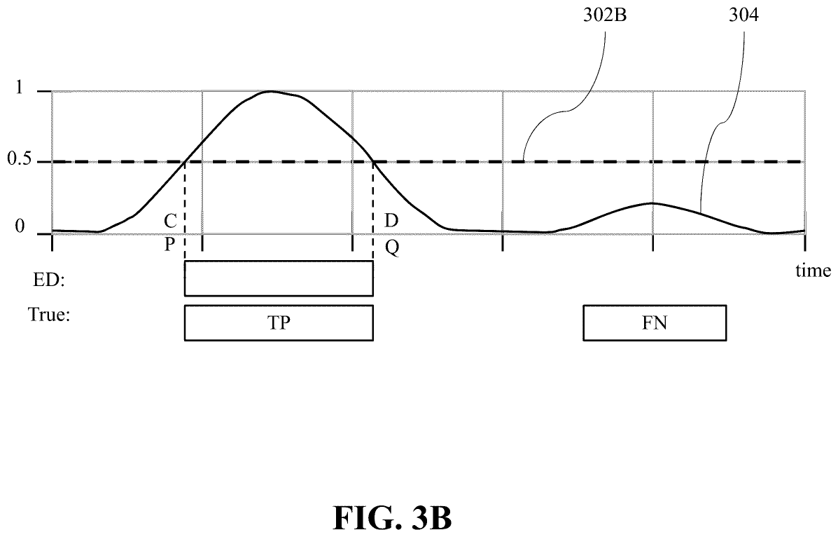

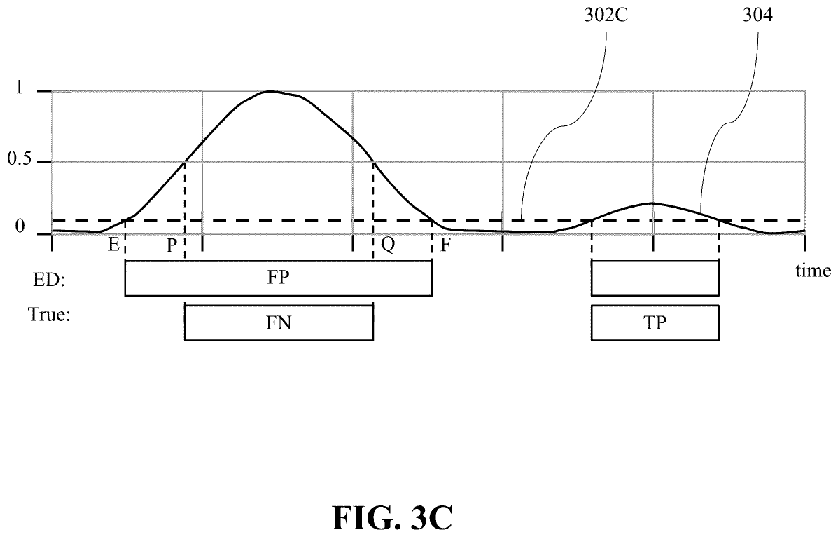

Some embodiments realize that the aforementioned conversion of event predictions centered around frame-level confidence thresholding has a detrimental effect on event boundary detection leading to false positive detections (FPs) and false negative detections (FNs) and is not suitable for several reasons. FIG. 3A, 3B, and 3C illustrate examples of event detections using different frame-level thresholds. The examples shown in FIG. 3A-3C may be considered to be representative of the frame-level presence confidence output for a single sound class of a sound event detection (SED) system. The plots show frame level scores 304 (expressed as probabilities between 0 and 1) mapped against time. Referring to FIG. 3A, when the value of threshold 302A is chosen to be high, fewer event detections are triggered (only the scores in 304 that are above the threshold 302A qualify). As such, the time span of the event detection extends from point A to point B on the time axis. Assuming the ground truth corresponding to the event detection occurs between points P and Q on the time axis, the event is not correctly detected (false negative) since it is shorter in time span than the ground truth thereby neglecting segments that should have been included in the event detection.

Referring to FIG. 3B, when the value of threshold 302B is chosen to be medium, as compared to the scenario with FIG. 3A, a larger number of frame-level detections are triggered. As such, the time span of the event detection extends from point C to point D on the time axis. Assuming that here as well, the ground truth corresponding to the event detection candidate occurs between points P and Q on the time axis, the detected candidate leads to true positive considerations since the event candidate is equal in time span with the ground truth.

Referring to FIG. 3C, when the value of threshold 302C is chosen to be low, as compared to the scenario with FIG. 3A and 3B, an even larger number of frame-level detections is triggered. As such, the time span of the event detection candidate extends from point E to point F on the time axis. Assuming that here as well, the ground truth corresponding to the event detection candidate occurs between points P and Q on the time axis, the detected event overestimates the ground truth event resulting in the detected event being false positive (false alarm) and the ground truth event being false negative (missed hit).

It is evident from FIGS. 3A-3C that changing the threshold also leads to change in the timespan (boundary) of the event detection. Consider a typical intersection-based evaluation based on the ground-truth events that requires the use of a required intersection rate of ρDTC=ρGTC=0.7 for both the detection tolerance criterion (DTC) and ground-truth intersection criterion (GTC), i.e., predictions must intersect with a ground-truth event by at least 70% to not be FP and ground-truth events must be covered by detections by at least 70% to be TP. It can be observed that, when gradually lowering the threshold down from 1, we will first get a prediction corresponding to the first ground-truth event, but with an underestimated extent, leading to FN. When lowering the threshold further, that matching prediction remains, but its predicted extent grows longer to the point where it yields TP. However, when lowering the threshold even further, the predicted extent will ultimately grow overestimated yielding now both FN and FP, even as we might get a TP in predicting the second ground-truth event. TPs turning back to FNs (i.e., having the true positive rate decrease) when the threshold decreases is different from standard binary classification tasks. As can be observed, this is ultimately because the threshold that detects the correct extent depends on the geometry of the frame-level scores (e.g., the overall peak heights in the case of FIGS. 3A-3C).

As such no threshold could get both ground-truth events right at the same time in the examples illustrated in FIGS. 3A-3C. This demonstrates that frame-level thresholding is suboptimal for event detection due to the event-level entanglement of both boundary and confidence information in the frame-level scores.

Accordingly, some example embodiments propose to decouple extent and confidence prediction using event bounding boxes (EBBs) as a new output format of the event detection system. Some embodiments modify the event detection system 100 of FIG. 1 to perform event detection based on the principle that the temporal extent of event candidates should be determined independently from the event candidate confidence score. Particularly, some embodiments modify the post processing operations 206 such that the output of the event detection system is not treated as a detected event. Instead, the output of event detection system is utilized to define EBBs corresponding to each event detection. An event-level thresholding is then employed to control a system's sensitivity without affecting the temporal extents of event predictions. In particular, even if the decision threshold is lowered far below an EBB's confidence score, the temporal extent does not change. This ensures not to disturb high-confidence event detections when using low decision thresholds, such as in applications aiming for a high recall. For example, in case of sound event detections, with sound event bounding boxes (SEBBs), monotonically increasing ROC curves are thus guaranteed again, and sound event candidates of high and low confidence, as in the above example, may be jointly detected correctly.

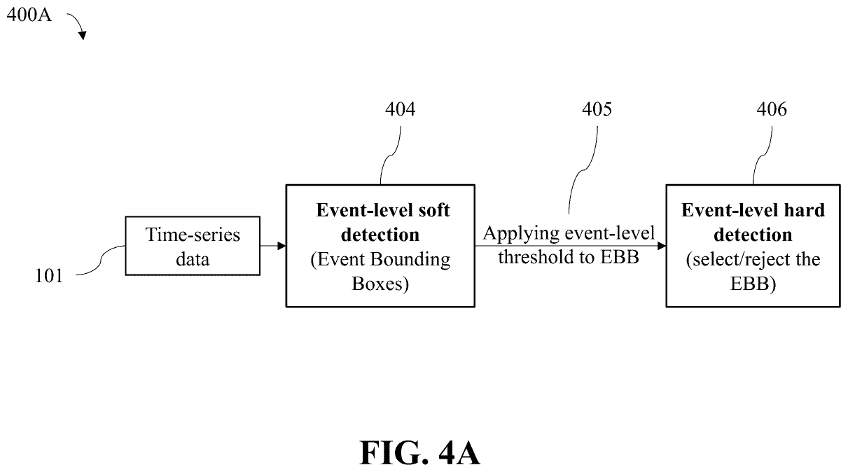

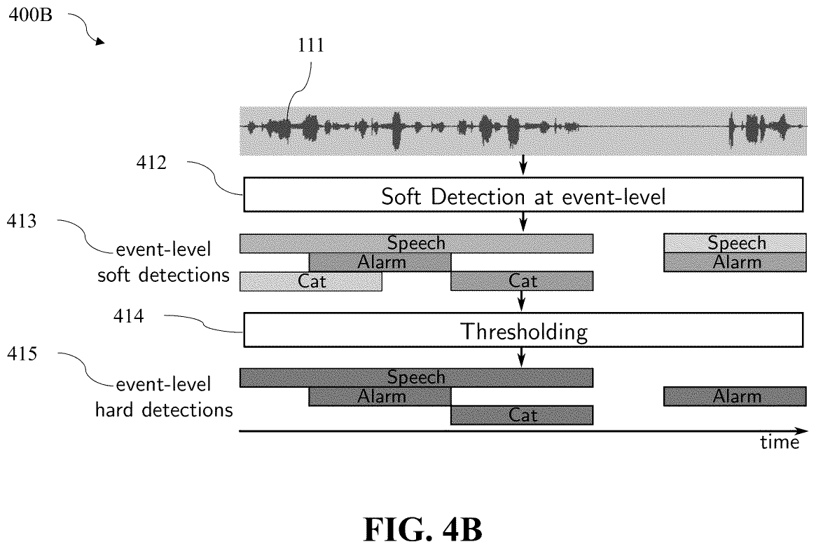

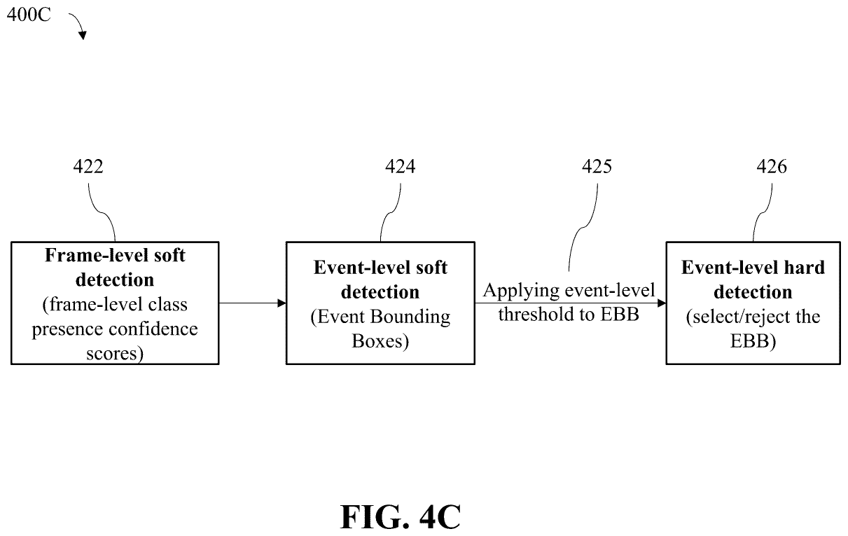

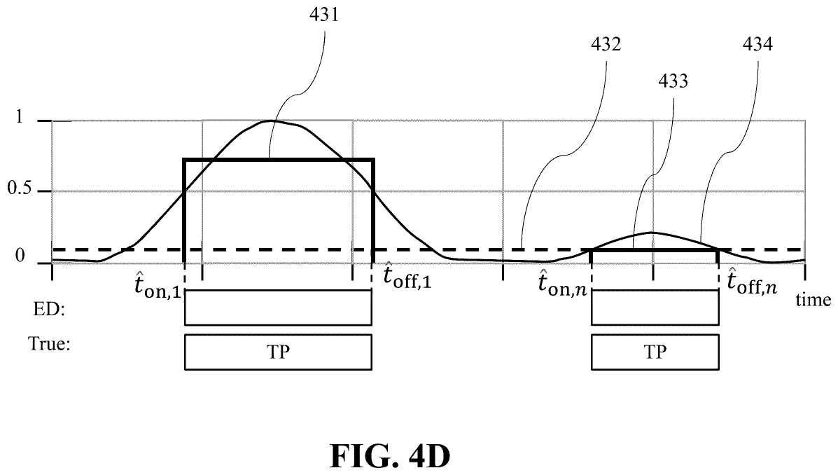

FIG. 4A illustrates a framework 400A for generating event-level hard detections from time series data, according to some example embodiments. The framework 400A may first perform event-level soft detection 404, also referred to as “event bounding box detection”, from the time-series data 101. Some embodiments may perform the EBB detection/event-level soft detection 404 in an end-to-end manner. According to some other embodiments, the EBB detection/event-level soft detection 404 may be performed by first performing frame-level soft detections which are then converted into the event-level soft detections 404. Although the following description provides details of generating event-level hard detections from time-series data using an end-to-end approach and frame-level soft detections, it may be contemplated that other suitable methods for EBB detection from time-series data may also be incorporated into the framework 400A.

According to some embodiments, event-level hard detections 406 may be generated from the time series data using end-to-end event bounding box detection 404 followed by event-level thresholding 405. Here, the prediction model for 404 could be a neural network that takes as input the time series data 101 and directly predicts the values (ĉⱼ, \hat{t}_{on,j}, \hat{t}_{off,j}, y̅ⱼ). Note, however, that the number of EBBs within the time-series data 101 may vary. Some example embodiments still output a fixed number of EBBs for each input time series such that the neural network has a fixed output size for example: 4 (values defining an EBB) times the fixed number of predicted EBBs. The number of predicted EBBs is chosen as an upper bound of the actual EBBs that are to be predicted. The additional predicted EBBs are provided with low (or even zero) confidence values, and as such they are irrelevant for the final detection. Other example embodiments may employ a sequence-to-sequence approach, where a neural network encoder encodes the time series data and an autoregressive neural network decoder outputs 5 values at a time—4 values defining an EBB plus a stop indicator value indicating whether the current predicted EBB was the last one. If not, the autoregressive decoder generates another output. After EBBs have been predicted, event-level hard detections 406 are generated using event-level thresholds 405.

Some example embodiments provide approaches specifically tailored for sound event detection. FIG. 4B illustrates a modified framework 400B for event detection. The modified framework comprises performing event-level soft detection 413, where a detection model 412 outputs a list of event candidates each associated with a single soft value between 0 and 1 representing an event presence probability. In the example shown in FIG. 4B, six candidates have been detected namely (“Speech” from 0 s to 5 s with 70% prob.; “Speech” from 6 s to 8 s with 30% prob.; “Alarm” from 1 s to 3 s with 60% prob; “Alarm” from 6 s to 8 s with 55% prob; “Cat” from 0 s to 2 s with 20% prob.; “Cat” from 3 s to 5 s with 80% prob). Then thresholding 414 is performed at event-level which either accepts a candidate as hard detection 415 if its probability exceeds the employed threshold or else discards it.

FIG. 4C illustrates a framework 400C for generating event-level soft detections 424 from frame-level soft detections 422 and then converting the event-level soft detections 424 into event-level hard detections 426, according to some example embodiments. The event level soft detections 424 may be obtained from frame-level soft detections 422 which is described next. According to some embodiments, the framework 400C may comprise computing for each frame of time-series data, the probability of an event class being present in a frame. This gives frame-level soft detections 422 which can be expressed as the frame-level class presence confidence scores. Then, time spans are inferred, e.g., by applying a change detection algorithm on the scores. Each inferred timespan corresponds to the timespan of an event bounding box (EBB). Further, an overall scalar confidence is assigned with each EBB by aggregating (e.g., averaging) the frame-level confidence scores over all frames within the EBB's time span, which gives event-level soft detection 424. In mathematical terms, EBBs are expressed as quadruples \hat{b}ⱼ=(ĉⱼ, \hat{t}_{on,j}, \hat{t}_{off,j}, y̅ⱼ) which intuitively represents an event candidate defined by event class ĉⱼ, a fixed extent given by onset time \hat{t}_{on,j} and offset time \hat{t}_{off,j}, plus an overall presence confidence score y̅ⱼ.

The EBBs 424 may be generated/defined in any suitable way. Some non-limiting examples of the EBBs 424 include threshold-based EBB, change detection-based EBB, and hybrid EBB, each of which is described later in the disclosure considering audio data as an example. Irrespective of the type of EBBs, an event-level threshold may be applied to each of the event bounding boxes to generate event-level hard detection by selecting the EBBs that satisfy the event-level threshold.

FIG. 4D illustrates an exemplary graphical representation of an event detection output format as event bounding boxes, according to some example embodiments. Referring to FIG. 4D, for each of the event detection candidates, an EBB (431, 433) may be defined such that the timespan of the event detection candidate remains between \hat{t}_{on,j} and \hat{t}_{off,j}. For example, for the EBB 431 the timespan of the corresponding event detection candidate stretches from \hat{t}_{on,1} to \hat{t}_{off,1} and for the EBB 433 the timespan of the corresponding event detection candidate stretches from \hat{t}_{on,n} to \hat{t}_{off,n}. For each EBB, the average of the frame-level scores 433 falling within the time segment \hat{t}_{on,j} and \hat{t}_{off,j} determines the height of the EBB. An event detection using the EBB is performed by imposing an event prediction threshold 432 to the EBB.

From FIG. 4C, it may be observed that altering the event prediction threshold 432 does not alter the timespan of the corresponding event detection candidate, thereby leading to a robust event detection framework.

In some embodiments, the detected event may correspond to a sound event and the corresponding EBB may be a sound EBB (SEBB). Some embodiments provide post-processing approaches to enable conversion of the frame-level multi-label presence confidence scores as inferred SEBBs, as described below.

Threshold-based SEBBs (tSEBBs): The output of a conventional frame-level threshold-based event detection yields the set of events (ĉⱼ, \hat{t}_{on,j}, \hat{t}_{off,j}). Applying a class threshold (frame-level detection threshold) to the probability of presence of the event class ĉⱼ in each frame of the time-series data yields frames (or segments) whose probability of presence exceeds the class threshold. A time of occurrence of a sequentially first frame of the frames whose probability of presence exceeds the class threshold may then be selected as the start time instance (\hat{t}_{on,j}) of the event detection candidate and a time of occurrence of a sequentially last frame of the frames whose probability of presence exceeds the class threshold may be selected as the end time instance (\hat{t}_{off,j}) of an event. Thus, the frame-level detection thresholding is only used to determine the events' extents. According to some embodiments, the frame-level class probability of the frames falling in between \hat{t}_{on,j} and \hat{t}_{off,j} may then be aggregated (e.g., averaged) to determine an overall presence confidence score y̅ⱼ yielding SEBBs (ĉⱼ, \hat{t}_{on,j}, \hat{t}_{off,j}, y̅ⱼ). According to some other embodiments, as an alternate to the averaging, the maximum or median confidence score falling in between \hat{t}_{on,j} and \hat{t}_{off,j} may be selected as the overall presence confidence score y̅ⱼ. At inference time y̅ⱼ may be compared with an event-level threshold to turn tSEBBs into predicted events. Thresholds can be set jointly with optional (median) filter hyper-parameters (altering frame-level class probabilities before thresholding) through tuning on a validation set.

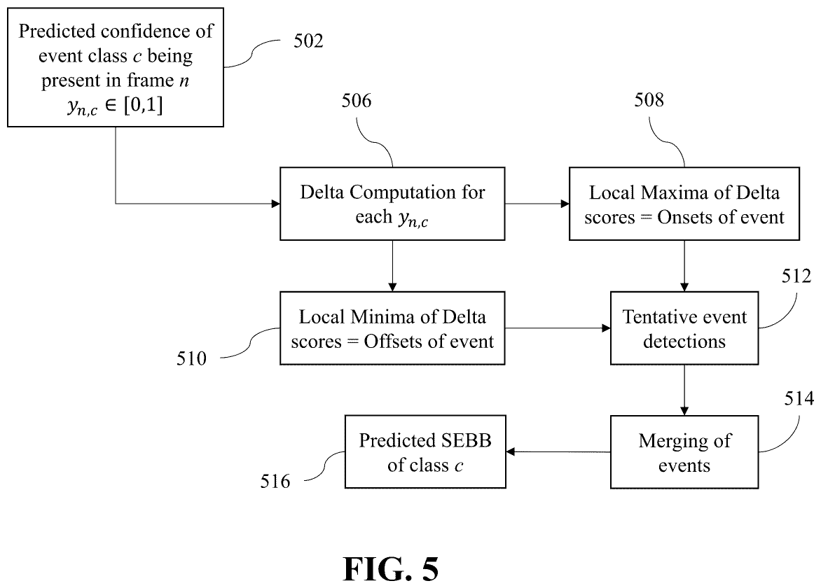

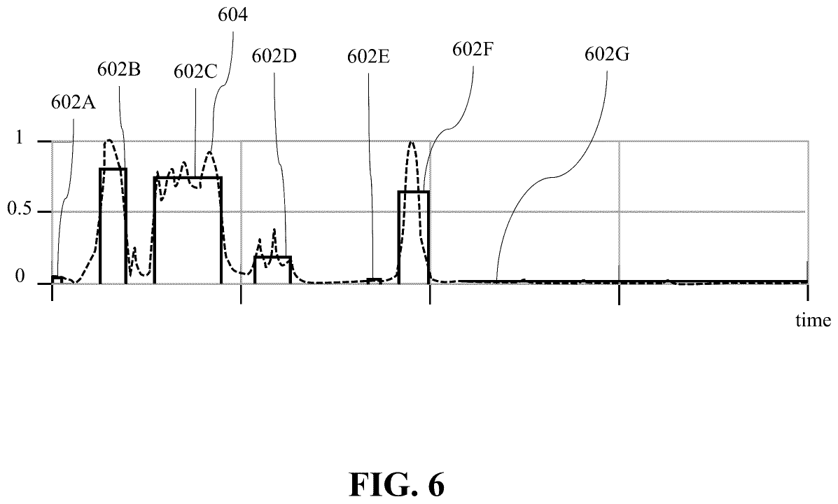

Change-detection-based SEBBs (cSEBBs): Some example embodiments provide a change-detection-based algorithm for converting output of frame-level event detection into cSEBBs. FIG. 5 illustrates a workflow of a method for change-detection based prediction of sound event bounding boxes from frame-level class presence confidence scores, according to some example embodiments. The framework illustrated in FIG. 5 predicts cSEBBs by post-processing of frame-level soft detections but does not include any frame-level thresholding. Instead, the framework relies on detecting the SEBBs' onset and offset times by detecting points in time where frame-level soft scores change a lot, i.e., either significantly increase (local change/delta maxima) or decrease (local change/delta minima). FIG. 6 illustrates a graphical representation of the change-detection based sound event bounding boxes, according to some example embodiments. Referring to FIG. 5, the algorithm begins by computing 506 “delta” (i.e., change) scores by filtering the frame-level class presence confidence scores y_{n,c} 502 with an ideal step filter in continuous time. As different systems use different frame lengths, the filtering is performed in continuous time, interpolating the frame-level class presence confidence scores y_{n,c} 502 as framewise constant. As such, for filter length τ_{c} (in seconds), a delta score corresponds to the difference between the average of y_{n,c} in the next τ_{c}/2 seconds and the previous τ_{c}/2 seconds.

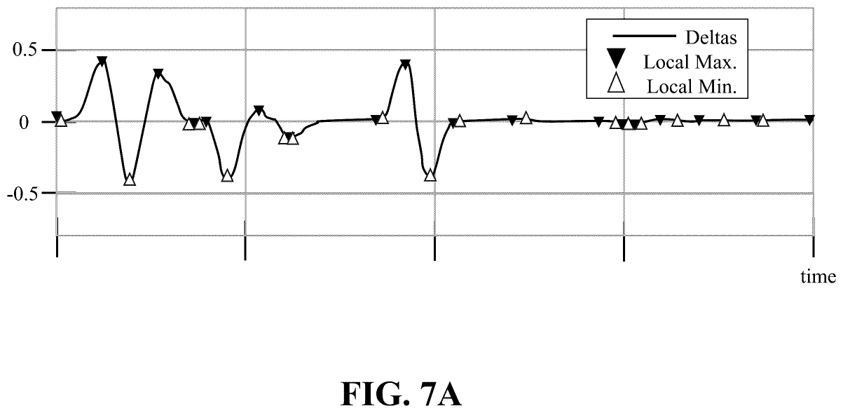

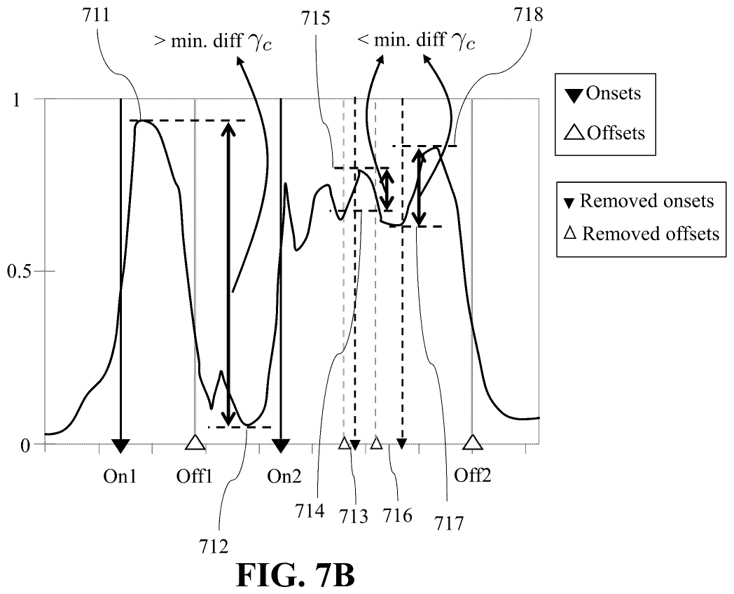

From the delta scores, local maximas 508 and local minimas 510 of the delta scores are determined as illustrated in FIG. 7A. The local maximas 508 of the delta scores become tentative onsets while the local minimas 510 of the delta scores become tentative offsets. Together, the tentative onsets and offsets form “tentative events” 512 between each onset and the next offset. The gaps between the tentative events, i.e., between each offset and the next onset, shall be referred to as tentative gaps.

In some scenarios, some of the tentative gaps may be due to only small spurious variations of the frame-level class presence confidence scores y_{n,c}. In such scenarios, some embodiments employ merging 514 of tentative events as described next with reference to FIG. 7B. For every tentative gap, its lowest y_{n,c} is compared with the highest y_{n,c} in the tentative events immediately preceding and following it (i.e., with the highest value of whichever event has the higher max). If the comparison falls under a predefined minimum difference (min. diff.) γ_{c}, the tentative offsets and onsets around the gap segment are removed and the preceding tentative event, the tentative gap, and the following tentative event are merged into one event. For example, referring to FIG. 7B, for the tentative gap between offset point Off1 and onset point On2, the difference between the lowest y_{n,c} 712 and the highest y_{n,c} 711 in the preceding or following tentative event (where here the highest y_{n,c} is in the preceding event) is larger than the min. diff. γ_{c}. Hence, the gap is not removed/the events are not merged. The same comparison is performed for the two other tentative gaps 713, 716. In both cases (713, 716) the difference between the lowest y_{n,c} 714, 717 in the gap and the highest y_{n,c} 715, 718 in the preceding and following tentative event (where in both cases 713 and 716 the highest y_{n,c} is in the following events) is less than the min. diff. γ_{c}. Hence, these gaps are removed, and tentative events are merged into a single event with onset On2 and offset Off2. The difference measure between the likelihoods can be either absolute (e.g., if max value is less than 0.1 larger than min value, the gap is removed) or relative (e.g., if max value is less than 50% larger than min value, the gap is removed).

Finally, a predicted cSEBB 516 of class c from each remaining onset is formed as \hat{t}ₒₙ, the following remaining offset as \hat{t}_{off}, and the aggregation (e.g., average) of the y_{n,c} between \hat{t}ₒₙ and \hat{t}_{off} as y̅. The class-dependent filter length τ_{c} and threshold γ_{c} (either absolute or relative) are the hyperparameters to tune on a validation set. To perform event prediction, the cSEBB predicted at 516 is subjected to event-level thresholding.

Referring to FIG. 6, for frame-level class presence confidence scores 604, the method of FIG. 5 may be implemented to yield cSEBBs 602A-602G.

Hybrid SEBBs (hSEBBs): Some embodiments also propose a hybrid of the two previous approaches, where a set of hSEBBs are predicted as follows. First, tSEBBs are predicted for given frame-level class presence confidence scores in the manner described previously with respect to tSEBBs. The tSEBBS with a confidence higher than an event-level threshold λ_{c,tsebbs} are adopted as hSEBBS and may then be complemented by predicting cSEBBs. Any cSEBB that overlaps with a tSEBB is discarded. The predicted cSEBBs then may find additional SEBBs inside which y_{n,c} was consistently below the tSEBB prediction threshold λ_{c,ext}. Then the following class-level hyperparameters may be tuned on a validation set: median filter lengths, λ_{c,ext}, and λ_{c,tsebbs} for tSEBB prediction and {τ_{c}, γ_{c}} for cSEBB prediction.

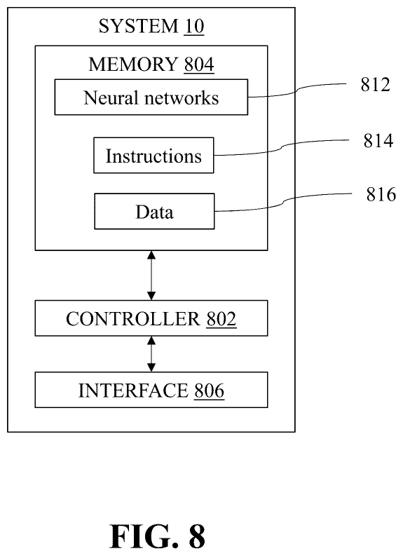

FIG. 8 illustrates some components of the event detection-based control system 10 of FIG. 1A, according to some embodiments. The system 10 comprises a controller 802, a memory 804, and an interface 806. The controller 802 accesses the memory 804 to execute one or more processes for performing event detection in time-series data and control of a machine in accordance with the detected event(s). The memory 804 stores, amongst other things, different modules of the system 10 as discussed with reference to FIGS. 1A and 1B. For example, the memory 804 may store various neural networks, computer executable instructions 814 and data 816 all of which are accessible to the controller 802. The controller 802 invokes the modules and data during training and/or execution phases. The controller communicates input and output data of the system 10 through the one or more interfaces 806.

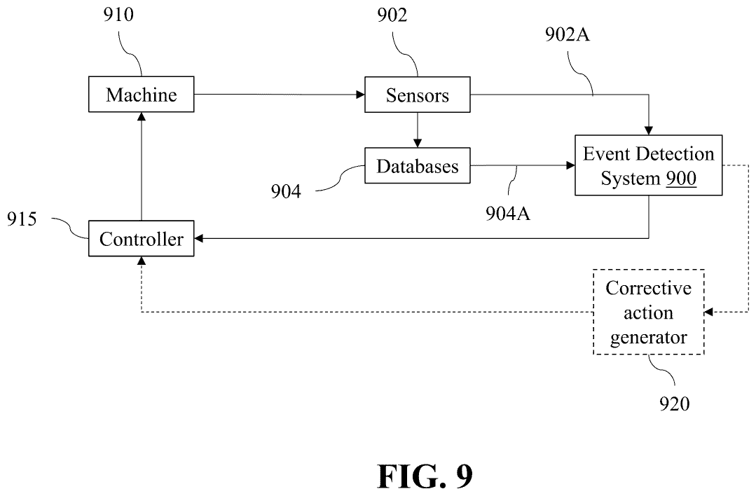

FIG. 9 illustrates an example use case of an event detection system 900 of FIG. 1B in accordance with some example embodiments. The event detection system 900 collects/obtains from one or more sensors 902, time-series data indicative of time-varying operations of a machine 910. For example, the time-series data may be audio data associated with the operation of the machine 910. According to some example embodiments, the time-series data may be stored in one or more databases 904 and the event detection system 900 may access the database to collect the time-series data. Regardless of the manner of collection, the event detection system 900 processes the time-series data to perform event detection in accordance with one or more of the frameworks described with respect to FIGS. 4A-7B. For example, the system 900 may detect one or more anomalous events pertaining to audible noise emanating from the operation of the machine 910 that indicate anomalous or unusual operation of the machine. Particularly, the event detection system 900 may output the timespan and the overall confidence of the event class (anomalous operation) in each detected event. According to some embodiments, the system 900 may transmit the detected events directly to one or more controllers 915 for generating control commands that modify one or more operating points of the machine 910. According to some other embodiments, the system 900 may transmit the detected events to a corrective action generator 920 that analyzes the detected events and generates one or more control commands corresponding to the detected events. These commands may define values of one or more control parameters of the machine and upon execution by the controller 915, these commands may cause the machine to return to a state of normal operation.

For example, the machine 910 may be a motor and the time-series data may be an audio stream capturing sound produced by the motor during operation. In such scenarios, the event detection system 900 may process the time-series data in accordance with one or more embodiments described previously to identify one or more events indicating noisy operation by the motor (i.e., the intensity or pitch of the sound produced by the motor being above a normal value). The detected events may indicate time stamps of the noisy operation which may be correlated with operational parameters of the motor by the controller 915 or the corrective action generator 920 (as the case may be) to infer anomalous operational states of the motor. Accordingly, the controller 915 and/or the action generator 920 may adjust the operational states of the motor to restore noiseless operation of the motor.

The above description provides exemplary embodiments only, and is not intended to limit the scope, applicability, or configuration of the disclosure. Rather, the following description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the following description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicated like elements. Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine-readable medium. A processor(s) may perform the necessary tasks. Various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine. Typically, the functionality of the program modules may be combined or distributed as desired in various embodiments.

Embodiments of the present disclosure may be embodied as a method, of which an example has been provided. The acts performed as part of the method may be ordered in any suitable way. Accordingly, embodiments may be constructed in which acts are performed in an order different than illustrated, which may include performing some acts concurrently, even though shown as sequential acts in illustrative embodiments. Further, use of ordinal terms such as “first,” “second,” in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. Although the present disclosure has been described with reference to certain preferred embodiments, it is to be understood that various other adaptations and modifications can be made within the spirit and scope of the present disclosure. Therefore, it is the aspect of the appended claims to cover all such variations and modifications as come within the true spirit and scope of the present disclosure.

What is claimed is:

1. A computer-implemented method for event detection in time-series data, wherein the method uses a processor coupled with a memory configured to store instructions implementing the method, wherein the instructions, when executed by the processor carry out steps of the method, comprising:
processing the time-series data to make a hard decision on a time span of an event indicative of continuous activity of the event within the time-series data and make a soft decision on a presence of the event for the entire time span;
applying an event-level threshold to the soft decision on the presence of the event for the entire time span to produce a result of the event detection; and
outputting the result of the event detection.

2. The method of claim 1, wherein the soft decision is an event bounding box that comprises the time span of the event, a type of the event, and a confidence score for the presence of the event.

3. The method of claim 2, wherein the time-series data comprises an audio stream, wherein the event is a sound event, and wherein the soft decision is a sound event bounding box that comprises a sound class of the sound event as the type of the event, the time span as an extent of the sound event in the audio stream, and an overall confidence score indicating the probability of presence of the sound class in the sound event.

4. The method of claim 3, further comprising controlling a machine based on the result of the event detection.

5. The method of claim 3, further comprising identifying a source of a sound associated with the detected sound event, based on the result of the event detection.

6. The method of claim 3, wherein making the hard decision on the time span comprises identifying frames in the audio stream that belong to the sound class.

7. The method of claim 6, wherein identifying the frames that belong to the sound class comprises:
computing a probability of presence of the sound class in each frame of the audio stream; and
applying a class threshold to the probability of presence of the sound class in each frame to filter a plurality of frames whose probability of presence exceeds the class threshold.

8. The method of claim 7, wherein making the hard decision on the time span further comprises determining a start time instance and an end time instance of the time span based on the plurality of filtered frames.

9. The method of claim 8,
wherein a time of occurrence of a sequentially first frame of the plurality of filtered frames is selected as the start time instance of the time span and a time of occurrence of a sequentially last frame of the plurality of filtered frames is selected as the end time instance of the time span.

10. The method of claim 1, wherein processing the time-series data to make the soft decision on the presence of the event for the entire time segment comprises computing a composite confidence score based on the probability of presence of the sound class in each frame of the entire time span.

11. The method of claim 10, wherein the computing includes one or more of obtaining the average, obtaining the maximum, obtaining the minimum, or obtaining the median of the probability of presence of the sound class in each frame of the entire time span.

12. The method of claim 3, further comprising:
computing for each frame of the audio stream, a class presence confidence score as a probability of presence of the sound class in each frame of the audio stream;
filtering the class presence confidence scores with an ideal step filter in continuous time to determine a delta score for each frame as a difference between the average of class presence confidence scores in a predefined time period after a respective frame and the average of class presence confidence scores in the same-length time period before the respective frame;
determining tentative onset times and tentative offset times of tentative events from the delta scores; and
processing the tentative onset times and tentative offset times of tentative events to obtain time spans of sound events.

13. The method of claim 12, wherein the processing of the tentative onset times and tentative offset times of tentative events further comprises:
computing for each gap between two tentative events the maximum difference between a frame-level confidence score within the gap and a frame-level confidence score in the preceding or following tentative event; and
removing at least one gap by removing the tentative offset time and onset time around the at least one gap, when the maximum difference is smaller than a predefined merging threshold, wherein the merging threshold is one of an absolute merging threshold or a relative merging threshold,
wherein the maximum difference is smaller than the absolute merging threshold if the value of the difference is less than the value of the absolute merging threshold, and the maximum difference is smaller than the relative merging threshold if the value of the difference is smaller than the value of the product of the relative merging threshold with the minimum score in the gap.

14. A system for event detection in time-series data, comprising:
a memory configured to store computer-executable instructions; and
one or more processors configured to execute the instructions to:
process the time-series data to i.) make a hard decision on a time span of an event indicative of continuous activity of the event within the time-series data and make a soft decision on a presence of the event for the entire time span;
apply an event-level threshold to the soft decision on the presence of the event for the entire time span to produce a result of the event detection; and
output the result of the event detection.

15. The system of claim 14, wherein the time-series data comprises an audio stream, and wherein the soft decision comprises a sound class of a detected sound event in the audio stream and the time span as an extent of the detected sound event in the audio stream.

16. The system of claim 15, wherein the one or more processors are further configured to control a machine based on the result of the event detection.

17. The system of claim 15, wherein the one or more processors are further configured to identify a source of a sound associated with the detected sound event, based on the result of the event detection.

18. The system of claim 15, wherein to make the hard decision on the time span, the one or more processors are further configured to identify frames in the audio stream that belong to the sound class.

19. The system of claim 18, wherein to identify the frames in the audio stream that belong to the sound class, the one or more processors are further configured to:
compute a probability of presence of the sound class in each frame of the audio stream; and
apply a class threshold to the probability of presence of the sound class in each frame to filter a plurality of frames whose probability of presence exceeds the class threshold.

20. The system of claim 19, wherein to make the hard decision on the time segment, the one or more processors are further configured to determine a start time instance and an end time instance of the time span based on the plurality of filtered frames.
